(19) United States
(12) Patent Application Publication
(10) Pub. No.: US 2004/0049867 A1
(43) Pub. Date: Mar. 18, 2004

(54) Electric toothbrush with in-use activation of bristles

(75) Inventor: Fung Kut Hui, Cityone (HK)

Correspondence Address: LEYDIG VOIT & MAYER, LTD, 700 THIRTEENTH ST. NW, SUITE 300, WASHINGTON, DC, 20005-3960, US

(73) Assignee: Chiaphua Industries Limited, Tai Po (HK)

(21) Appl. No.: 10/242,567

(22) Filed: Sep. 13, 2002

(51) Int. Cl. A61C 17/22

(52) U.S. Cl. 15/22.1; 15/28

(57) ABSTRACT

An electric toothbrush apparatus includes a longitudinal drive shaft, an in-use activated tuft block, at least a portion of which is movably associated with the apparatus, and having a bearing surface that is driven directly or indirectly by the drive shaft. The in-use activated tuft block will not oscillate until its bristles are pressed against the user's teeth in use so as to close a gap behind the bearing surface.

### BACKGROUND OF THE INVENTION

The present invention relates to electric toothbrushes. More particularly, although not exclusively, the invention relates to an electric toothbrush having a tuft block that oscillates pivotally when bristles of the tuft block are pressed against something such as the user's teeth or gums in-use.

Some known electric toothbrushes have a tuft block that is driven by an elongated drive shaft to oscillate about an axis. The drive shaft usually extends through the neck of the toothbrush or replaceable brushing attachment. The drive shaft might have a radial extension that fits into a slot formed in the tuft block to cause the oscillation. Although such toothbrushes provide an efficient cleaning action, the action is limited to arcuate oscillation of the bristles of the tuft block about the block's pivot axis. The cleaning action of such an electric toothbrush could be improved by providing a secondary tuft block that oscillates in a manner different to that of the primary tuft block.

Toothbrushes with more than one tuft block have been proposed. However, they have complex drive arrangements comprising numerous parts that interact with one another to cause movement of a secondary tuft block. Further, the movement of the secondary tuft block is usually the same type of movement as the movement of the primary tuft block (i.e. movement about a pivot axis parallel to the pivot axis of the primary tuft block), adding little improvement to the overall brushing action.

Furthermore, in known electric toothbrushes, when the motor is running, the primary, and if present—the secondary tuft block must move. This is because of the direct interaction of the tuft block(s) with the drive mechanism and can cause toothpaste applied to the bristles to vibrate loose and fall to the basin or floor, prior to insertion of the bristles (and applied toothpaste) into the user's mouth.

### OBJECTS OF THE INVENTION

It is an object of the present invention to provide an improved electric toothbrush having a tuft block that oscillates only upon pressing its bristles against a surface such as the user's teeth to reduce the likelihood of toothpaste applied thereto being dislodged inadvertently.

It is a further object of the present invention to provide an electric toothbrush having a shaft-driven primary tuft block and a secondary tuft block driven by the same shaft but only when the secondary tuft block is pressed against the shaft in use.

It is still a further object of the present invention to provide an electric toothbrush having a shaft-driven primary tuft block and a secondary tuft block driven by the same shaft but only when the secondary tuft block is pressed against the shaft in use and so as to move in a manner different to movement of the primary tuft block.

### DISCLOSURE OF THE INVENTION

There is disclosed herein an electric toothbrush apparatus comprising:

a longitudinal drive shaft,

an in-use activated tuft block, at least a portion of which is movably associated with the apparatus, and having a bearing surface that is driven directly or indirectly by the drive shaft only when a gap adjacent to the bearing surface is closed or substantially closed in use.

Preferably the apparatus further includes:

a primary tuft block driven by the drive shaft to move about a primary pivot axis.

Preferably the in-use activated tuft block is pivotally mounted to the apparatus.

Preferably the in-use activated tuft block is mounted to pivot about a secondary pivot axis that extends in a direction that is different to the direction of the primary pivot axis.

Preferably the primary and secondary pivot axes extend substantially at right angles to one another.

Preferably the primary tuft block oscillates about the primary pivot axis.

Preferably the in-use activated tuft block oscillates about the secondary pivot axis in use.

Preferably the primary pivot axis extends substantially normally to the longitudinal axis of the drive shaft.

Preferably the secondary pivot axis extends in a direction across the longitudinal axis of the drive shaft.

Preferably the drive shaft includes an eccentric distal end portion and the primary tuft block further includes a slot extending substantially parallel to the primary pivot axis and into which eccentric distal end portion is received.

Preferably said eccentric distal end portion bears against the bearing surface of the in-use activated tuft block when said gap is closed.

Preferably the apparatus includes a housing within which the drive shaft is housed.

Preferably the drive shaft has a driven proximal end remote from said distal end portion.

The driven end typically includes torque input means for receiving torque from a motor.

Preferably the apparatus is formed integrally with a toothbrush handle within which a motor and battery are housed.

Alternatively, the apparatus is a replaceable attachment for attachment to a toothbrush handle within which a motor and battery are housed.

There is further disclosed herein electric toothbrush apparatus comprising:

a longitudinal drive shaft,

a primary tuft block driven by the drive shaft,

a secondary tuft block attached pivotally to the apparatus adjacent the primary tuft block and adapted to pivot passively in use.

Preferably the primary tuft block is driven by the drive shaft to pivot about a primary pivot axis.

Preferably the secondary tuft block is mounted to pivot about a secondary pivot axis that extends in a direction that is different to the direction of the primary pivot axis.

Preferably the primary and secondary pivot axes extend substantially at right angles to one another.

Preferably the primary tuft block oscillates about the primary pivot axis.

Preferably the primary pivot axis extends substantially is normally to the longitudinal axis of the drive shaft.

Preferably the secondary pivot axis extends in a direction across the longitudinal axis of the drive shaft.

Preferably the drive shaft includes an eccentric distal end portion and the primary tuft block further includes a slot extending substantially parallel to the primary pivot axis and into which an eccentric distal end portion of the drive shaft is received.

Preferably the drive shaft has a driven proximal end remote from said distal end portion.

Preferably the driven end typically includes torque input means for receiving torque from a motor.

Preferably the apparatus is formed integrally with a toothbrush handle within which a motor and battery are housed.

Alternatively the apparatus can be a replaceable attachment for attachment to a toothbrush handle within which a motor and battery are housed.

### BRIEF DESCRIPTION OF THE DRAWINGS

Preferred forms of the present invention will now be described by way of example with reference to the accompanying drawings, wherein:

FIG. 1 is a schematic partially cross-sectional perspective illustration of the bristle-end portion of an electric toothbrush, or toothbrush bristle attachment,

FIG. 2 is a schematic plan view of an alternative toothbrush bristle attachment,

FIG. 3 is a schematic cross-sectional elevational view of the attachment taken at III-III in FIG. 2, and

FIG. 4 is a schematic cross-sectional end elevational view of the attachment of FIG. 2 taken at IV-IV in FIG. 3.

### DESCRIPTION OF THE PREFERRED EMBODIMENTS

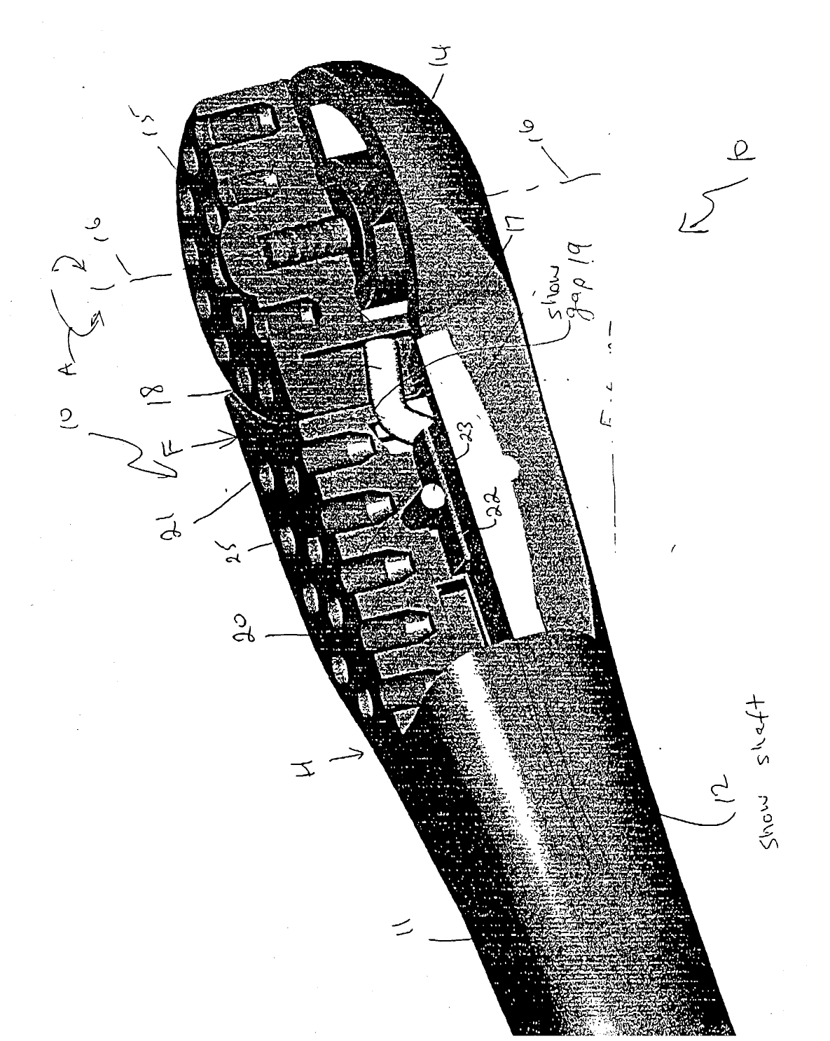

In FIG. 1 there is schematically depicted a brushing attachment 10 of an electric toothbrush. As an alternative, the attachment 10 could be an integral neck portion of a toothbrush, the handle of which receives a rechargeable battery, a motor and possibly a gearbox transmission. In the depicted embodiment however, the attachment 10 includes a neck 11 within which there is housed a drive shaft 12, the proximal end 13 of which receives the output torque of the motor or gearbox.

At the distal end of the drive shaft 12, there is provided an eccentric portion 18. This portion 18 is received within a slot 17 of a primary tuft block 15.

Primary tuft block 15 is mounted to the distal end portion 14 of the attachment 10 so as to oscillate about an axis 16. End portion 14 provides a housing for the tuft blocks. The pivot axis of the primary tuft block extends in a direction that is normal to the longitudinal extent of drive shaft 12. The primary tuft block oscillates in the directions indicated by double-ended arrow A. This might result from continuous rotation of the drive shaft 12 in one rotational direction, or might alternatively result from oscillatory pivotal rotation of the drive shaft 12 as might result if the drive shaft were to receive such pivotal oscillatory torque input from the motor instead of a continuous rotational input.

A secondary tuft block 20 has adjacent to it a bushing 22 through which a portion of the shaft 12 passes. The bushing 22 provides a rotational bearing for the drive shaft 12. The secondary tuft block also includes a pivot axle 23 having an axis which extends in a direction that is at 90 degrees to the direction of the axis 16 of the primary tuft block 15.

At one end of the secondary tuft block 20 there is provided a bearing surface 21 extending downwardly therefrom so as to engage with the eccentric portion 18 of the drive shaft 12. Adjacent to the primary tuft block 15.

There is a gap 19 between the bearing surface 21 and the eccentric portion 18 which is closed only when force F is applied to the secondary tuft block 20. This might result upon application of bristles (not shown) that extended from the apertures 25 to a user's teeth.

The above-described components are typically fabricated from moulded plastics material. However, the drive shaft, and perhaps the bearing surface 21 might be formed from a metallic material such as stainless steel for example.

In use, pressing a switch on the handle (not shown) activates the toothbrush. The drive shaft 12 either oscillates about its longitudinal axis or rotates continuously thereabout. As a result of this rotation of the drive shaft 12, the eccentric portion 18, due to its engagement within slot 17, induces pivotal movement of the primary tuft block 15 about axis 16 as described above.

During the above-described oscillation of the primary tuft block 15, the secondary tuft block 20 would not necessarily oscillate. That is, the eccentric portion 18 of the drive shaft 12 would simply rotate or oscillate beneath the bearing surface 21 of the secondary tuft block. The size of the gap 19 would change accordingly.

Only when a force F is applied to the secondary tuft block, will the gap 19 close. As a result, interaction of the eccentric portion 18 with the bearing surface 21 would result in pivotal oscillation of the secondary tuft block 20 so long as the bristles were maintained in contact with the user's teeth.

A biasing means such as a spring of low spring-force might be provided to maintain the gap 19 until a force F, overcoming the spring-force is applied to the secondary tuft block.

It should be appreciated that modifications and alterations obvious to those skilled in the art are not to be considered as beyond the scope of the present invention. For example, and particularly in an embodiment comprising a biasing spring, the axle 23 might be moved further away from the primary tuft block 15 such that the force F need not be concentrated so much to one end of the secondary tuft block. Also, the secondary tuft block might be formed of a flexible material with some inherent elasticity by which it maintains a gap 19 between the bearing surface 21 and eccentric,portion 18 until force F is applied. The secondary tuft block might be an integral part of the neck portion 11 having an integral thin hinge portion providing this described elasticity. That is, the secondary tuft block might be cantilevered from the neck 11 by a thin hinge portion at position H.

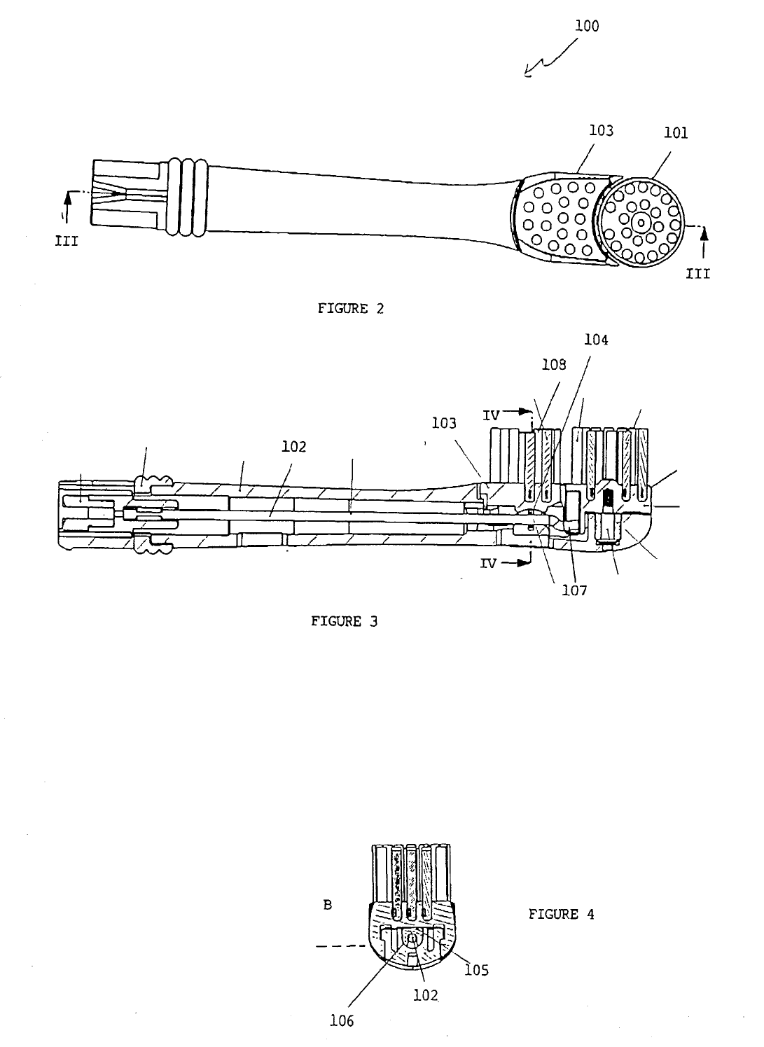

In FIGS. 2 to 4 of the accompanying drawings, there is depicted an alternative bristle attachment for an electric toothbrush. This attachment is generally indicated by reference numeral l00. Attachment 100 includes a primary tuft block 101 formed and configured in much the same manner as block 15 shown in FIG. 1.

The attachment 100 includes a drive shaft 102 formed and configured in much the same manner as drive shaft 22 depicted in FIG. 1. These parts will therefore not be described again in detail.

In the embodiment of FIGS. 2 to 4, a secondary tuft block 103 includes a concave bearing surface 104 at its under-side. Bearing surface 104 bears against a convex bearing surface 105 formed upon a bushing 106 through which the drive shaft 102 passes. In this embodiment, the drive shaft end portion 107 does not interact with the secondary tuft block 103. Instead, when the bristles 108 engage with the user's teeth, the secondary tuft block 103 pivots, or rocks passively back and forth about an axis generally indicated at B in FIG. 4. Axis B extends in a direction transverse to the longitudinal axis of the driveshaft 102, beneath the secondary tuft block. This axis is at the centre of curvature of the bearing surfaces 104 and 105. In an alternative construction the secondary tuft block could pivot about an axis that extends parallel to the driveshaft or at any other angle. Still further, the secondary tuft block could be mounted on a ball and socket joint to pivot in my direction depending on the direction of reaction force applied by a user's teeth to the bristles of he secondary tuft block.

1. An electric toothbrush apparatus comprising:
a longitudinal drive shaft,
an in-use activated tuft block, at least a portion of which is movably associated with the apparatus, and having a bearing surface that is driven directly or indirectly by the drive shaft only when a gap adjacent to the bearing surface is closed or substantially closed in use.

2. The apparatus of claim 1, further including:
a primary tuft block driven by the drive shaft to move about a primary pivot axis.

3. The apparatus of claim 1, wherein the in-use activated tuft block is pivotally mounted to the apparatus.

4. The apparatus of claim 2, wherein the in-use activated tuft block is mounted to pivot about a secondary pivot axis that extends in a direction that is different to the direction of the primary pivot axis.

5. The apparatus of claim 4, wherein the primary and secondary pivot axes extend substantially at right angles to one another.

6. The apparatus of claim 2, wherein the primary tuft block oscillates about the primary pivot axis.

7. The apparatus of claim 4, wherein the in-use activated tuft block oscillates about the secondary pivot axis in use.

8. The apparatus of claim 2, wherein the primary pivot axis extends substantially normally to the longitudinal axis of the drive shaft.

9. The apparatus of claim 5, wherein the secondary pivot axis extends in a direction across the longitudinal axis of the drive shaft.

10. The apparatus of claim 2, wherein the drive shaft includes an eccentric distal end portion and the primary tuft block further includes a slot extending substantially parallel to the primary pivot axis and into which eccentric distal end portion is received.

11. The apparatus of claim 10, wherein said eccentric distal end portion bears against the bearing surface of the in-use activated tuft block when said gap is closed.

12. The apparatus of claim 1 further including a housing within which the drive shaft is housed.

13. The apparatus of claim 1, wherein the drive shaft has a driven proximal end remote from said distal end portion.

14. The apparatus of claim 13, wherein the driven end typically includes torque input means for receiving torque from a motor.

15. The apparatus of claim 1 being formed integrally with a toothbrush handle within which a motor and, battery are housed.

16. The apparatus of claim 1 being a replaceable attachment for attachment to a toothbrush handle within which a motor and battery are housed.

17. An electric toothbrush apparatus comprising:
a longitudinal drive shaft,
a primary tuft block driven by the drive shaft,
a secondary tuft block attached pivotally to the apparatus adjacent the primary tuft block and adapted to pivot passively in use.

18. The apparatus of claim 17 wherein the primary tuft block is driven by the draft shaft to move about a primary pivot axis.

19. The apparatus of claim 18, wherein the secondary tuft block is mounted to pivot about a secondary pivot axis that extends in a direction that is different to the direction of the primary pivot axis.

20. The apparatus of claim 19, wherein the primary and secondary pivot axes extend substantially at right angles to one another.

21. The apparatus of claim 17, wherein the primary tuft block oscillates about the primary pivot axis.

22. The apparatus of claim 19, wherein the primary pivot axis extends substantially normally to the longitudinal axis of the drive shaft.

23. The apparatus of claim 22, wherein the secondary pivot axis extends in a direction across the longitudinal axis of the drive shaft.

24. The apparatus of claim 20, wherein the drive shaft includes an eccentric distal end portion and the primary tuft block further includes a slot extending substantially parallel to the primary pivot axis and into which an eccentric distal end portion of the drive shaft is received.

25. The apparatus of claim 17, wherein the drive shaft has a driven proximal end remote from said distal end portion.

26. The apparatus of claim 25, wherein the driven end typically includes torque input means for receiving torque from a motor.

27. The apparatus of claim 17 being formed integrally with a toothbrush handle within which a motor and battery are housed.

28. The apparatus of claim 17 being a replaceable attachment for attachment to a toothbrush handle within which a motor and battery are housed.
